(19) United States
(12) Patent Application Publication
(10) Pub. No.: US 2024/0033954 A1
(43) Pub. Date: Feb. 1, 2024

(54) UTILITY KNIFE WITH TAPE BREAKING STRUCTURE

(71) Applicant: TECHTRONIC CORDLESS GP, Anderson, SC (US)

(72) Inventors: Trevor C. Fauss, Greenville, SC (US); Thomas Evatt, Six Mile, SC (US); Charles Moody Wacker, II, Anderson, SC (US)

(21) Appl. No.: 17/876,361

(22) Filed: Jul. 28, 2022

(51) Int. Cl. B26B 1/08; B26B 5/00

(52) U.S. Cl. CPC B26B 1/08; B26B 5/003

(57) ABSTRACT

A utility knife includes a housing extending along a longitudinal axis and defining a slot at a front surface of the housing and a blade coupled to the housing at least partially within the slot and movable relative to the housing between an exposed position and an enclosed position. The housing includes a cutter structure extending from the front surface of the housing along the longitudinal axis adjacent to the slot. The cutter structure defines a cutting edge. In the exposed position, the blade at least partially extends from the housing adjacent to the cutter structure.

### TECHNICAL FIELD

The present invention relates to a utility knife, and in particular, a utility knife that includes a tape-breaking structure extending from the housing.

### BACKGROUND

A utility knife with a retractable blade can be used to cut various materials. However, the use of the retractable blade to cut certain materials with adhesives (e.g., tape) may result in the adhesives on the blade, which is undesirable.

### SUMMARY

A utility knife according to one or more embodiments includes a housing extending along a longitudinal axis and defining a slot at a front surface of the housing, and a blade coupled to the housing at least partially within the slot and movable relative to the housing between an exposed position and an enclosed position. The housing includes a cutter structure extending from the front surface of the housing along the longitudinal axis adjacent to the slot. The cutter structure defines a cutting edge. In the exposed position, the blade at least partially extends from the housing adjacent to the cutter structure.

According to one or more embodiments, the cutter structure includes a flat surface and a curved surface that intersect to define the cutting edge.

According to one or more embodiments, the cutter structure includes a flat surface extending from an edge of the opening, and the flat surface is configured to guide a replacement blade into the slot.

According to one or more embodiments, the utility knife further includes a slider at least partially protruding from the housing, and a blade retainer is slidably supported in the housing. The blade is coupled to the blade retainer, which is coupled to the slider. The blade is slidable relative to the housing between the exposed position and the enclosed position.

According to one or more embodiments, the utility knife further includes a base that is coupled to the housing and movable between an open position and a closed position. The base includes a pair of tabs extending from the base and engaging the housing when the base is in the closed position.

According to one or more embodiments, the base includes a pivot portion that engages the housing, and the base pivots between the open position and the closed position.

According to one or more embodiments, the base includes a pocket to store blades.

According to one or more embodiments, the housing further defines a gap, the blade defines a blade edge, and the blade edge traverses the gap when the blade is in the enclosed position such that the blade edge is visible through the gap.

A utility knife according to one or more embodiments includes a housing extending along a longitudinal axis and defining a slot formed at a front surface of the housing. The housing includes an insertion guide extending from the front end of the housing and defining a guide surface. The guide surface is positioned adjacent to the slot. The guide surface is configured to guide a replacement blade into the slot.

According to one or more embodiments, the guide surface is a substantially flat surface extending in the longitudinal direction.

According to one or more embodiments, the insertion guide extends at least partially along the slot.

According to one or more embodiments, the utility knife further includes a blade retainer supported in the housing and configured to receive a blade guided by the guide surface. The blade defines a retaining slot. The blade retainer includes a retaining tab. The retaining tab is disposed in the retaining slot when the blade is inserted through the slot.

According to one or more embodiments, the utility knife further includes a blade release supported by and extending from the housing. The blade release is selectively engageable with the blade retainer. The blade release selectively engages the retaining tab to remove the retaining tab from the retaining slot.

According to one or more embodiments, the utility knife the insertion guide defines a cutting edge at a front end of the guiding surface.

A utility knife according to one or more embodiments includes a first scale coupled to a second scale and defining a slot therebetween. The second scale includes a cutter structure defining an insertion surface and a cutting edge. The cutter structure is disposed adjacent to the slot and extends at least partially along the slot.

According to one or more embodiments, the utility knife further includes a base including a pair of tabs extending from the base, the base pivotally coupled to the first scale and the second scale, the pair of tabs engaging the first scale and the second scale and maintaining the base in a closed position.

According to one or more embodiments, the base includes a pocket portion disposed between the first scale and the second scale when the base is in the closed position, the pocket portion receiving a plurality of blades.

According to one or more embodiments, the first scale and the second scale define a gap, the blade edge of the blade traversing the gap when the blade is in the enclosed position.

According to one or more embodiments, the utility knife further includes a blade having a blade edge. The blade is coupled to the second scale and movable relative to the first scale and the second scale between an enclosed position and an exposed position. The blade extends at least partially through the slot in the exposed position.

According to one or more embodiments, the blade is slidable relative to the first scale and the second scale.

Other aspects of the invention will become apparent by consideration of the detailed description and accompanying drawings.

### BRIEF DESCRIPTION OF THE DRAWINGS

FIG. 1 is a perspective view of a utility knife according to one or more embodiments of the present invention.

FIG. 2 is a front view of the utility knife according to FIG. 1.

FIG. 3 is a top view of the utility knife according to FIG. 1, showing the blade in an exposed position.

FIG. 4 is a top view of the utility knife according to FIG. 1, showing the blade in an enclosed position.

FIG. 5 is a first side view of the utility knife according to FIG. 1.

FIG. 6 is a second side view of the utility knife according to FIG. 1, with the first scale removed.

FIG. 7 is a perspective view of the utility knife according to FIG. 1, with the first scale removed.

FIG. 8 is a perspective view of the blade retainer, slider, blade, and blade release of the utility knife according to FIG. 1.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways.

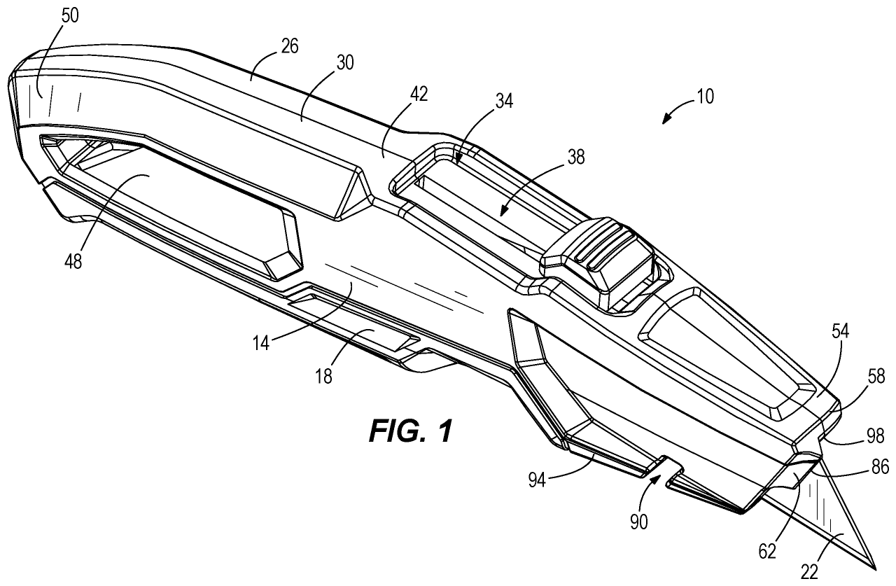

FIG. 1 illustrates an exemplary utility knife 10 according to one or more embodiments of the present invention. The utility knife 10 includes a housing 14 and a base 18 that is pivotally coupled to the housing 14. A blade 22 can be removably coupled to the housing 14 and is movable relative to the housing 14.

The housing 14 includes a first scale 26 coupled to a second scale 30. The first scale 26 is coupled to the second scale 30 by threaded fasteners, rivets, glue, snapped-fit or other appropriate fastening method. The first and second scales 26, 30 are composed of metal, plastic, or other durable material capable of withstanding scratches, drops, etc. The housing 14 defines a slider recess 34 and a sliding slot 38 on a first side 42 of the housing 14. The housing 14 further defines a grip portion 46 at a first end 50 of the housing 14 and a cutting portion 54 at the opposite, second end 58 of the housing 14. The grip portion 46 is graspable by a user for handling the utility knife 10. The blade 22 can be partially disposed in the housing 14 and at least partially extend from the second end 58 of the housing 14. A cutter structure 62 also extends forward from the second end 58 of the housing 14.

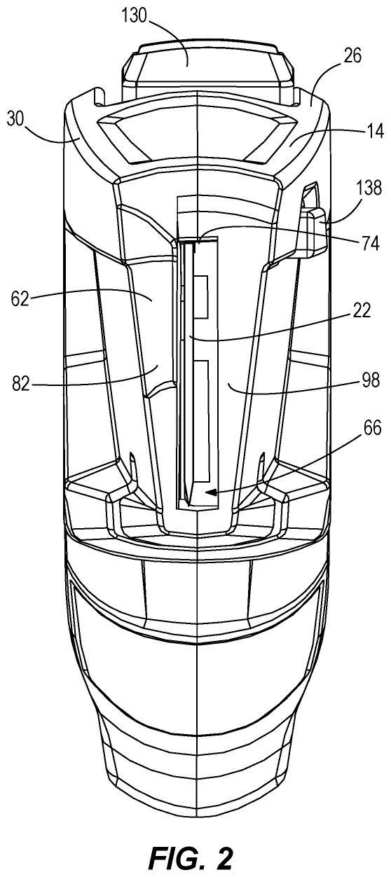

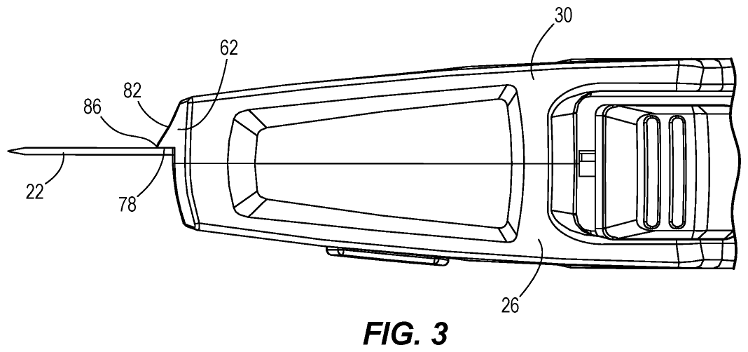

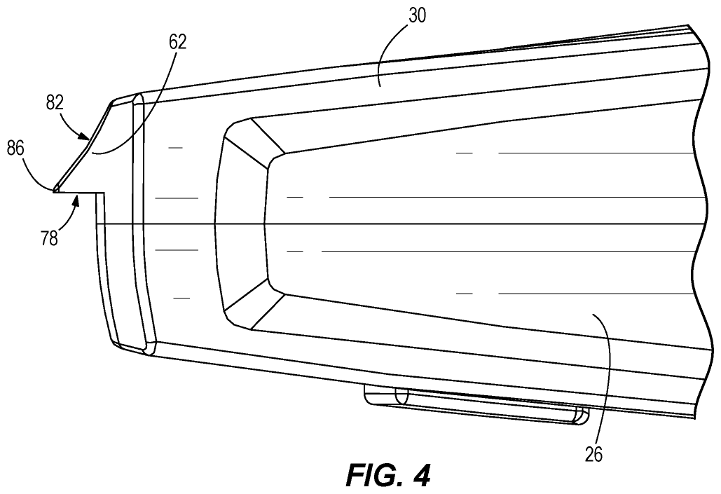

With reference to FIG. 2, the housing 14 defines a slot 66 positioned at the second end 58. The slot 66 communicates an interior 70 of the housing 14. The cutter structure 62 extends from the second scale 30 and is positioned adjacent the slot 66 at a first, or top, end 74 of the slot 66. The cutter structure 62 may instead by positioned on the first scale 26 adjacent the slot 66. The cutter structure 62 extends at least partially along the slot 66, for instance, about half of the length of the slot 66. As shown in FIGS. 3 and 4, the cutter structure 62 has a first face, or guide surface 78 that is generally flat, and extends parallel to a blade 22 that is coupled to the housing 14. The guide surface 78 provides a blade insertion ledge 78a. The cutter structure 62 defines a second face 82 that, together with the guide surface 78, define a cutting edge 86. The second face 82 is illustrated as having a curved, or concave, profile, but may instead have a flat or convex profile. The cutting edge 86 is sufficiently pointed to cut or sever a piece of adhesive tape, for instance, a piece of adhesive tape that has been applied to a cardboard box for the purpose of securing the doors of the cardboard box but is not sufficiently pointed to break or cut the skin of a user and cause injury during use of the cutter structure 62.

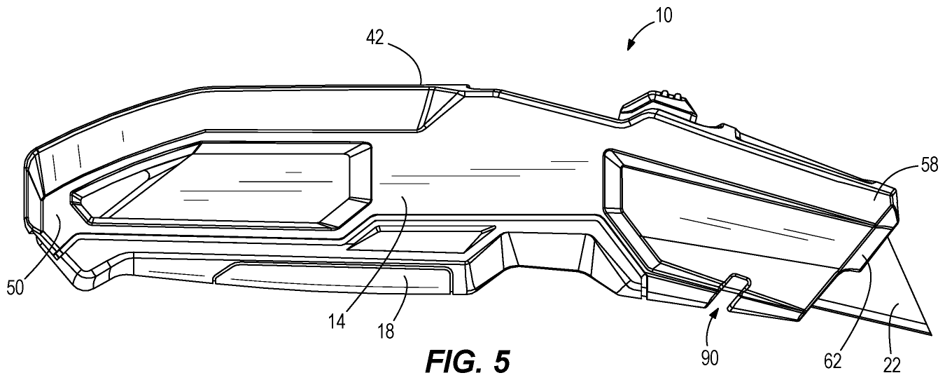

Returning to FIG. 1, the housing 14 further defines a gap 90 extending from the second, or bottom, side 94. The gap 90 communicates the interior 70 of the housing 14. As shown in FIG. 5, the gap 90 extends generally parallel to the second end face 98 of the housing 14.

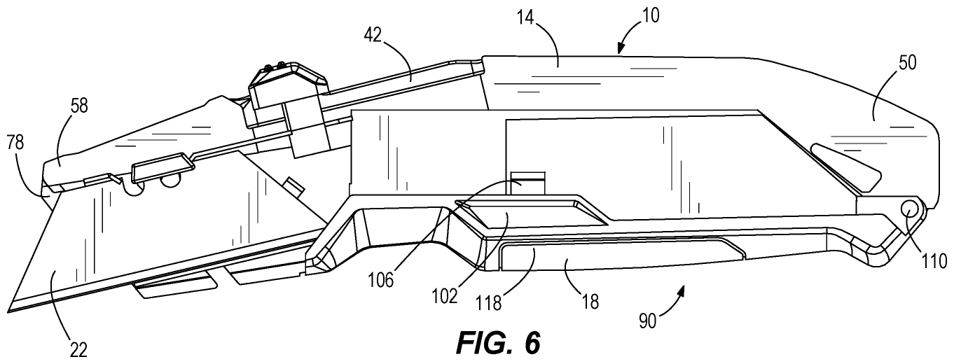

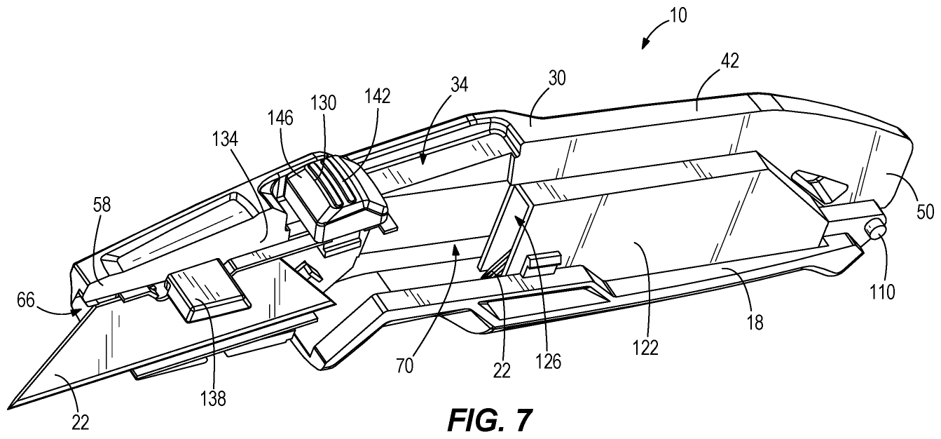

With reference to FIGS. 5 and 6, the base 18 is movably coupled to the housing 14 at the second side 94. With continued reference to FIG. 6, the base 18 includes a pair of grip portions 102 and a pair of clips 106 extend from the base 18 adjacent the grip portions 102. The base 18 may instead include more or fewer tabs. The base 18 also includes a pair of pivots 110 at a first end 114 of the base 18 that engage the housing 14. In that regard, the base 18 is pivotable about the pivots 110 between an open position (not shown) and a closed position 118. In the closed position 118, the clips 106 engage the base 18 and maintain the base 18 in the closed position 118. In another embodiment, the base 18 may instead be slidable relative to the housing 14. With reference to FIG. 7, the base 18 defines a pocket portion 122 positioned in the interior 70 of the housing 14 between the first and second scales 26, 30 when the base 18 is in the closed position 118. The pocket portion 122 includes a cavity 126, the cavity 126 being sized to receive a plurality of blades 22.

With reference to FIG. 7, the utility knife 10 includes a slider 130, a blade retainer 134, and a blade release 138. The slider 130 is at least partially disposed in the housing 14 and protrudes from the housing 14 through the sliding slot 38. The slider 130 includes an engagement portion 142 that is disposed in the slider recess 34. The slider 130 is movable between a forward position 146 (shown in FIG. 7) that is closer to the second end 58 of the housing 14, and a rearward position 150 that is closer to the first end 50 of the housing 14.

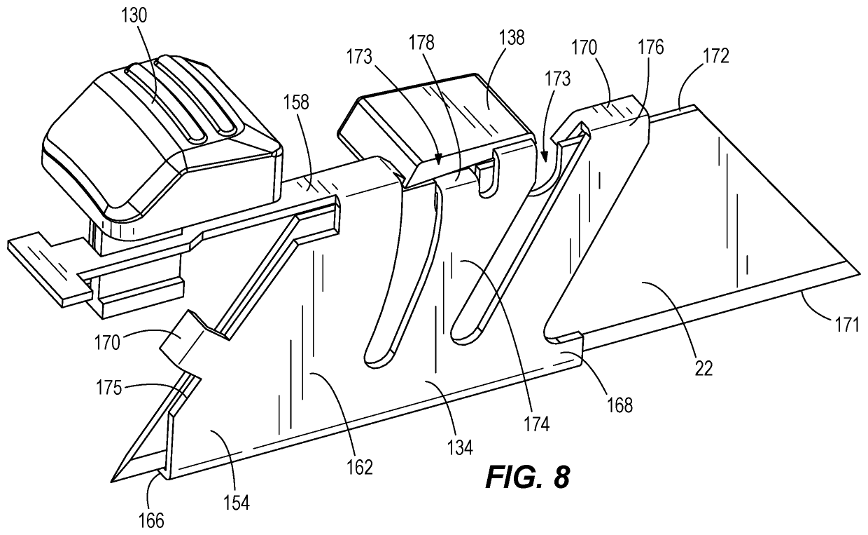

With reference to FIG. 8, the blade retainer 134 has a blade retention portion 154 and a slider engagement portion 158 that extends from the blade retention portion 154 toward the first end 50 of the housing 14 and engages the slider 130. The blade retention portion 154 includes a retainer body 162 that is generally flat. A shelf 166 extends from the bottom end 168 of the retainer body 162 and is generally perpendicular to the retainer body 162 which retains the blade 22 in a vertical direction. A plurality of retainer tabs 170 extend from the retainer body 162 and retain the blade 22 in other directions relative to the retainer body 162. In that regard, the blade 22 may be trapezoidal, rectangular, or other shape, and includes a blade edge 171 that is sharpened and an opposite, second edge 172 that has at least one retaining slot 173 defined in the blade 22. A retainer tab 170 extends from the retainer body 162 on a first side 175 of the retainer body 162 that is closer to the first end 50 of the housing 14. Another retainer tab 170 extends from the retainer body 162 on a top side 176 of the retainer body 162 that is closer to the first side 42 of the housing 14. A locking tab 174 extends from the retainer body 162 in a cantilevered manner and has an end portion 178 that extends perpendicular to the retainer body 162 toward the first scale 26. As shown in FIG. 2, the blade release 138 is supported in the housing 14 and extends outward from the housing 14 beyond the first scale 26. The blade release 138 is movable between a depressed position 182 and a released position (not shown).

As shown in FIGS. 4 and 7, the blade 22 can be removably inserted into the housing 14 through the slot 66 and coupled to the blade retainer 134. With reference to FIG. 4, the blade insertion ledge 78a of the cutter structure 62 guides insertion of the blade 22 through the slot 66. the blade 22 abuts the blade insertion ledge 78a to guide the blade 22 into and through the slot 66 by providing a guide surface 78 against which the blade 22 can engage to reduce the likelihood that a user would miss the slot 66. Returning to FIG. 7, the blade 22 is received by the retainer body 162 of the blade retainer 134. In that regard, the shelf 166 and retainer tabs 170 guide the blade 22 relative to the retainer body 162 and constrain movement of the blade 22 thereby preventing movement of the blade 22 in a direction beyond the retainer body 162. The blade 22 is inserted through the slot 66 such that the blade edge 171 is closer to the second side 94 of the housing 14 and the second edge 172 of the blade 22 is closer to the cutter structure 62. When the blade 22 is inserted and coupled to the blade retainer 134, the locking tab 174 is disposed in the retaining slot 173 of the blade 22.

When the blade 22 is coupled to the blade retainer 134, the slider 130 is slidable between the forward and rearward positions 146, 150 and the coupled interaction between the slider 130, blade retainer 134, and blade 22 slides the blade 22 between an exposed position 186 corresponding to the slider 130 being in the forward position 146 and the blade 22 being in an enclosed position 190 corresponding to the slider 130 being in the rearward position 150. In the exposed position 186, the blade 22 extends at least partially through the slot 66 beyond the housing 14 such that the blade edge 171 is exposed. In the enclosed position 190, the blade 22 is disposed entirely within the housing 14. When the blade 22 is disposed in the housing 14, the blade edge 171 traverses the gap 90 such that a user could insert twine into the gap 90 and cut the twine using the blade edge 171 while the user is protected from contacting the blade edge 171. In other embodiments of the utility knife 10, the blade 22, blade retainer 134, slider 130, and blade release 138 may be configured such that the blade 22 is pivoted between an enclosed position 190 and exposed position 186.

When the blade 22 is in the exposed position 186, the blade release 138 engages the end portion 178 of the locking tab 174. The blade release 138 is biased toward the released position (not shown) by the locking tab 174. By pressing the blade release 138 to overcome the bias imposed by the locking tab 174, the blade release 138 engages the end portion 178 and elastically deforms the locking tab 174 such that the end portion 178 is no longer disposed in the retaining slot 173 of the blade 22, allowing a user to remove the blade 22 from the housing 14.

The base 18 is pivotable about the pivots 110 between an opened position and a closed position 118. When the base 18 is in the closed position 118, the clips 106 engage the housing 14 thereby preventing rotation of the base 18 from the closed position 118. A user applies a force to the grip portions 102, such as by pinching, to elastically move the clips 106 out of engagement with the housing 14 thereby allowing the base 18 to pivot relative to housing 14 from the closed position 118. In the open position, a user can insert a plurality of blades 22 to the pocket portion 122 to store the blades 22 for future usage.

According to one or more embodiments, the cutter structure 62 may be used to cut tape instead of the blade 22 such that adhesive from the tape does not get transferred to the blade 22. According to one or more embodiments, the cutter structure 62 may include a guide surface 78 adjacent to a slot 66 that is configured to receive a replacement blade. Thus, when a user is inserting the replacement blade into the slot 66, one side of the replacement blade may be abutted against the guide surface 78 such that the replacement blade can be guided into the slot 66. According to one or more embodiments, the cutter structure 62 has a dual purpose to cut materials such as tape and to guide a replacement blade into the slot 66.

While the above example may be described in connection with a retractable knife with cutter structure in addition to a blade, the cutter structure described herein may be applicable to other types of tools. Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

1. A utility knife comprising:
a housing extending along a longitudinal axis and defining a slot at a front surface of the housing; and
a blade coupled to the housing at least partially within the slot and movable relative to the housing between an exposed position and an enclosed position,
wherein the housing includes a cutter structure extending from the front surface along the longitudinal axis adjacent to the slot,
wherein the cutter structure defines a cutting edge, and
wherein, in the exposed position, the blade at least partially extends from the housing adjacent to the cutter structure.

2. The utility knife of claim 1, wherein the cutter structure includes a flat surface and a curved surface that intersect to define the cutting edge.

3. The utility knife of claim 1, wherein the cutter structure includes a flat surface extending from an edge of the opening, and wherein the flat surface is configured to guide a replacement blade into the slot.

4. The utility knife of claim 1, further comprising:
a slider at least partially protruding from the housing; and
a blade retainer slidably supported in the housing,
wherein the blade is coupled to the blade retainer,
wherein the blade retainer is coupled to the slider, and
wherein the blade is slidable relative to the housing between the exposed position and the enclosed position.

5. The utility knife of claim 1, further comprising a base coupled to the housing and movable between an open position and a closed position, wherein the base includes a pair of tabs extending from the base and engaging the housing when the base is in the closed position.

6. The utility knife of claim 5, wherein the base includes a pivot portion engaging the housing, and wherein the base is configured to pivot between the open position and the closed position.

7. The utility knife of claim 5, wherein the base includes a pocket configured to store a plurality of blades.

8. The utility knife of claim 1, wherein the housing further defines a gap, wherein the blade defines a blade edge, and wherein the blade edge traverses the gap when the blade is in the enclosed position such that the blade edge is visible through the gap.

9. A utility knife comprising:
a housing extending along a longitudinal axis and defining a slot formed at a front surface of the housing, the housing including an insertion guide extending from the front end of the housing and defining a guide surface,
wherein the guide surface is positioned adjacent to the slot, and
wherein the guide surface is configured to guide a replacement blade into the slot.

10. The utility knife of claim 9, wherein the guide surface is a substantially flat surface extending in the longitudinal direction.

11. The utility knife of claim 9, wherein the insertion guide extends at least partially along the slot.

12. The utility knife of claim 9, further comprising a blade retainer supported in the housing and configured to receive a blade guided by the guide surface, wherein the blade defines a retaining slot, wherein the blade retainer includes a retaining tab, and wherein the retaining tab is disposed in the retaining slot when the blade is inserted through the slot.

13. The utility knife of claim 12, further comprising, a blade release supported by and extending from the housing, wherein the blade release is selectively engageable with the blade retainer, and wherein the blade release selectively engages the retaining tab to remove the retaining tab from the retaining slot.

14. The utility knife of claim 9, wherein the insertion guide defines a cutting edge at a front end of the guiding surface.

15. A utility knife comprising a first scale coupled to a second scale and defining a slot therebetween, wherein the second scale includes a cutter structure defining an insertion surface and a cutting edge, and wherein the cutter structure is disposed adjacent to the slot and extends at least partially along the slot.

16. The utility knife of claim 15, further comprising a base including a pair of tabs extending from the base, the base pivotally coupled to the first scale and the second scale, the pair of tabs engaging the first scale and the second scale and maintaining the base in a closed position.

17. The utility knife of claim 16, wherein the base includes a pocket portion disposed between the first scale and the second scale when the base is in the closed position, the pocket portion receiving a plurality of blades.

18. The utility knife of claim 15, wherein the first scale and the second scale define a gap, and wherein the blade edge of the blade traversing the gap when the blade is in the enclosed position such that the blade edge is visible through the gap.

19. The utility knife of claim 15, further comprising a blade having a blade edge, wherein the blade is coupled to the second scale and movable relative to the first scale and the second scale between an enclosed position and an exposed position, and wherein the blade extends at least partially through the slot in the exposed position.

20. The utility knife of claim 15, wherein the blade is slidable relative to the first scale and the second scale.
